(19) United States
(12) Patent Application Publication
(10) Pub. No.: US 2008/0282044 A1
(43) Pub. Date: Nov. 13, 2008

(54) DATA CONTROL SYSTEM, CONTROL SERVER, DATA CONTROL METHOD, AND PROGRAM

(76) Inventors: Mitsuhiro Kimura, Kanagawa (JP); Tomoharu Hikita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/116,034

(22) Filed: May 6, 2008

(30) Foreign Application Priority Data
May 9, 2007 (JP) 2007-124773

(51) Int. Cl. G06F 12/00

(52) U.S. Cl. 711/155; 711/E12.001

(57) ABSTRACT

There is provided a data control system that includes a control server and an information processing terminal equipped with a non-contact type IC chip. The information processing terminal includes a chip memory and a consistency check request portion. The chip memory includes at least one service area that stores a service data item and an index area that stores a link information item for accessing the service area. The consistency check request portion transmits a consistency check request. The control server includes a data acquisition portion that acquires the link information item according to the check request, an area determination portion that determines whether the corresponding service area exists for each link information item, a reading portion that reads the determined service area, and a data update portion that, if the service area could not be read, updates the link information item with information not indicating any access destination.

### CROSS REFERENCES TO RELATED APPLICATIONS

The present invention contains subject matter related to Japanese Patent Application JP 2007-124773 filed in the Japan Patent Office on May 9, 2007, the entire contents of which being incorporated herein by reference.

### BACKGROUND OF THE INVENTION

1. Field of the Invention

The present invention relates to a data control system, a control server, a data control method, and a program.

2. Description of the Related Art

In recent years, information processing terminals have come into widespread use that are capable of non-contact communication with a reader/writer, such as mobile telephones and the like that are provided with non-contact type integrated circuit (IC) cards (hereinafter called by their generally used name “smart cards”) or non-contact type IC chips.

Being provided with an IC chip that is tamper-proof makes the information processing terminal that is capable of non-contact communication with the reader/writer, as described above, able to transmit, receive, and update securely data, such as electronic money and the like, for example, for which data falsification is a problem. Therefore, the providing of services that utilize the information processing terminal that is capable of non-contact communication with the reader/writer is spreading throughout society. Moreover, along with the spread of those services, the use of the information processing terminals such as the mobile telephones and the like that are provided with non-contact type IC chips is also spreading.

It is in this context that services are starting to be provided that, when a user changes from one type of mobile telephone to another, for example, transfer data from the IC chip (a transfer source IC chip) in the mobile telephone used before the change to the IC chip (a transfer destination IC chip) in the mobile telephone used after the change. A technology that is involved in the transfer of the data from the transfer source IC chip to the transfer destination IC chip is disclosed in Japanese Patent Application Publication No. JP-A-2006-338423, for example.

A memory in a known IC chip (see Japanese Patent Application Publication No. JP-A-2006-338423, for example) has one memory area (a service area Z) that has a hierarchical structure that contains at least one area (a service area A, B, or the like), as shown in FIG. 1. In this case, the area is the equivalent of a folder in the hierarchical structure. The reader/writer, by specifying an identification code that is assigned to each area (the service area A, B, or the like), for example, performs reading and writing of a data item (service data item a, b, or the like) that are stored in each area (the service area A, B, or the like) in the IC chip.

The transfer of the data from the transfer source IC chip to the transfer destination IC chip is not limited to a case in which all of the data that are stored in the transfer source IC chip are transferred to the transfer destination IC chip. There are also cases in which a portion of the data that are stored in the transfer source IC chip is not transferred to the transfer destination IC chip. A case in which a portion of the data that are stored in the transfer source IC chip is not transferred to the transfer destination IC chip might be, for example, a case in which additional information to the effect that the data transfer is not permitted is attached to the data that are stored in the transfer source IC chip.

As described above, with a technology for transferring the data from the known transfer source IC chip to the transfer destination IC chip, a case can occur in which a portion of the data that are stored in the transfer source IC chip is not transferred to the transfer destination IC chip. Because the memory in the known IC chip has the one memory area that has the hierarchical structure that contains the at least one area, as shown in FIG. 1, no particular problem occurs, even in a case in which a portion of the data that are stored in the transfer source IC chip is not transferred to the transfer destination IC chip.

### SUMMARY OF THE INVENTION

However, the configuration of the IC chip memory is not limited to the one memory area that contains the at least one area. In some cases, the memory is configured to have two memory areas that are linked to one another. In the IC chip that has the two memory areas that are linked to one another, in a case in which a portion of the data that are stored in the transfer source IC chip is not transferred to the transfer destination IC chip, a state of inconsistency between one area and the other area can arise in the transfer destination IC chip. However, the technology that is involved in the transfer of the data from the known transfer source IC chip to the transfer destination IC chip is not designed for the IC chip that has the two memory areas that are linked to one another. Therefore, the technology cannot restore the two memory areas to a normal, consistent state from the state of inconsistency that can arise between the one area and the other area after the data transfer.

The present invention addresses the problem described above and provides a data control system, a control server, a data control method, and a program that are new and improved and that, in a case where the transfer of the data from the transfer source IC chip to the transfer destination IC chip is performed, are capable of restoring consistency to the memory area of the transfer destination IC chip that has the two memory areas that are linked to one another and is capable of non-contact communication with the reader/writer.

According to an embodiment of the present invention, there is provided a data control system that includes an information processing terminal and a control server. The information processing terminal is equipped with an IC chip that is capable of non-contact communication with a reader/writer, and the control server is capable of communication with the information processing terminal. The information processing terminal includes an internal memory and a consistency check request portion. The internal memory is provided within the IC chip and includes at least one service area and an index area. The at least one service area stores a service data item that corresponds to a service that is provided through the reader/writer. The index area stores a link information item for each of the at least one service area for the purpose of accessing the service area. The consistency check request portion transmits to the control server a consistency check request to check the consistency between the index area and the at least one service area after the performing of a data transfer to the IC chip from a transfer source IC chip that is distinct from the IC chip. The control server includes a data acquisition portion, an area determination portion, a reading portion, and a data update portion. The data acquisition portion acquires the at least one link information item from the index area of the information processing terminal in response to the consistency check request from the information processing terminal. The area determination portion, based on the link information item that was acquired by the data acquisition portion, determines whether or not the link information item indicates an accessible service area. The reading portion, in a case where it has been determined in the area determination portion that the link information item does indicate an accessible service area, reads the service area that is indicated by the link information item. The data update portion, in a case where the service area that is indicated by the link information item could not be read by the reading portion, updates the link information item with information that does not indicate any access destination.

The information processing terminal that is a configuring element of the data control system and is equipped with the IC chip includes, for example, the internal memory and the consistency check request portion. The internal memory is provided within the IC chip and can include the at least one service area and the index area. Each of the at least one service area can store the service data item that corresponds to the service that is provided through the reader/writer. The index area can store the link information item for each of the at least one service area for the purpose of accessing the service area. After the data transfer is made to the IC chip (a transfer destination IC chip) that is provided in the information processing terminal from the transfer source IC chip that is distinct from the IC chip (the transfer destination IC chip) that is provided in the information processing terminal, the consistency check request portion can transmit to the control server the consistency check request to check the consistency between the at least one service area and the at least one link information item that is stored in the index area in the IC chip (the transfer destination IC chip) that is provided in the information processing terminal.

The control server that is a configuring element of the data control system includes, for example, the data acquisition portion, the area determination portion, the reading portion, and the data update portion. The data acquisition portion can acquire the at least one link information item from the index area of the information processing terminal in response to the consistency check request from the information processing terminal. The area determination portion, based on the at least one link information item that was acquired by the data acquisition portion, can determine whether or not the link information item indicates an accessible service area. The reading portion, in a case where it has been determined in the area determination portion that the link information item does indicate an accessible service area, can read the service area that is indicated by the link information item, thus checking for the existence of the service area. The data update portion, in a case where the service area that is indicated by the link information item could not be read by the reading portion, can update the link information item with information that does not indicate any access destination.

This configuration makes it possible to achieve the data control system that, having the transfer destination IC chip that has two memory areas that are linked to one another and that is capable of non-contact communication with the reader/writer, is capable of restoring the consistency between the memory areas in the transfer destination IC chip in a case where the data transfer has been made from the transfer source IC chip to the transfer destination IC chip.

According to the embodiments of the present invention described above, there is provided a control server that is capable of communication with an information processing terminal that includes an internal memory within an IC chip that is capable of non-contact communication with a reader/writer. The internal memory includes at least one service area and an index area. The at least one service area stores a service data item that corresponds to a service that is provided through the reader/writer. The index area stores a link information item for each of the at least one service area for the purpose of accessing the service area. The information processing terminal is capable of transmitting a consistency check request to check the consistency between the index area and the at least one service area after the performing of a data transfer to the IC chip from a transfer source IC chip that is distinct from the IC chip. The control server includes a data acquisition portion, an area determination portion, a reading portion, and a data update portion. The data acquisition portion acquires the at least one link information item from the index area of the information processing terminal in response to the consistency check request from the information processing terminal. The area determination portion, based on the link information item that was acquired by the data acquisition portion, determines whether or not the link information item indicates an accessible service area. The reading portion, in a case where it has been determined in the area determination portion that the link information item does indicate an accessible service area, reads the service area that is indicated by the link information item. The data update portion, in a case where the service area that is indicated by the link information item could not be read by the reading portion, updates the link information item with information that does not indicate any access destination.

The control server can communicate with the information processing terminal that is equipped with the IC chip that is capable of non-contact communication with the reader/writer. The information processing terminal can be provided with the internal memory within the IC chip that is capable of non-contact communication with the reader/writer. The internal memory can include the at least one service area that can store the service data item that corresponds to the service that is provided through the reader/writer. The internal memory can also include the index area that can store the link information item for each of the at least one service area for the purpose of accessing the service area. After the data transfer is made to the IC chip (a transfer destination IC chip) that is provided in the information processing terminal from the transfer source IC chip that is distinct from the IC chip (the transfer destination IC chip) that is provided in the information processing terminal, the information processing terminal can transmit the consistency check request to check the consistency between the at least one service area and the at least one link information item that is stored in the index area in the IC chip (the transfer destination IC chip) that is provided in the information processing terminal.

The control server includes, for example, the data acquisition portion, the area determination portion, the reading portion, and the data update portion. The data acquisition portion can acquire the at least one link information item from the index area of the information processing terminal in response to the consistency check request from the information processing terminal. The area determination portion, based on the at least one link information item that was acquired by the data acquisition portion, can determine whether or not the link information item indicates an accessible service area. The reading portion, in a case where it has been determined in the area determination portion that the link information item does indicate an accessible service area, can read the service area that is indicated by the link information item, thus checking for the existence of the service area. The data update portion, in a case where the service area that is indicated by the link information item could not be read by the reading portion, can update the link information item with information that does not indicate any access destination.

This configuration makes it possible for the control server to restore the consistency between two memory areas that are linked to one another in the transfer destination IC chip that has the memory areas and that is capable of non-contact communication with the reader/writer, in a case where the data transfer has been made from the transfer source IC chip to the transfer destination IC chip.

The control server may also be provided with an attribute determination portion that, in a case where attribute information can be set for each of the at least one service area in the information processing terminal such that reading of the service area is made impossible and where the service area that is indicated by the link information item cannot be read by the reading portion, determines whether or not the attribute information has been set for the service area that is indicated by the link information item. The data update portion, in a case where it has been determined by the attribute determination portion that the attribute information has been set, may not then update the link information item that is stored in the index area.

This configuration makes it possible to check for the existence of the service area that is indicated by the link information item and to restore the consistency between the memory areas in the IC chip (the transfer destination IC chip) that is provided in the information processing terminal, even in a case where the attribute information can be set in the at least one service area in the IC chip (the transfer destination IC chip) that is provided in the information processing terminal such that reading of the service area is made impossible.

According to the embodiments of the present invention described above, there is provided a data control method in a control server that is capable of communication with an information processing terminal that includes an internal memory within an IC chip that is capable of non-contact communication with a reader/writer. The internal memory includes at least one service area and an index area. The at least one service area stores a service data item that corresponds to a service that is provided through the reader/writer. The index area stores a link information item for each of the at least one service area for the purpose of accessing the service area. The information processing terminal is capable of transmitting a consistency check request to check the consistency between the index area and the at least one service area after the performing of a data transfer to the IC chip from a transfer source IC chip that is distinct from the IC chip. The data control method includes a step of acquiring the at least one link information item from the index area of the information processing terminal in response to the consistency check request from the information processing terminal. The data control method also includes a step of determining, based on the acquired link information item, whether or not the link information item indicates an accessible service area. The data control method also includes a step of reading, in a case where it has been determined that the link information item does indicate an accessible service area, the service area that is indicated by the link information item. The data control method also includes a step of updating the link information item, in a case where the service area that is indicated by the link information item could not be read, with information that does not indicate any access destination.

Using this method makes it possible to restore the consistency between two memory areas that are linked to one another in the transfer destination IC chip that has the memory areas and that is capable of non-contact communication with the reader/writer, in a case where the data transfer has been made from the transfer source IC chip to the transfer destination IC chip.

According to the embodiments of the present invention described above, there is provided a program in a control server that is capable of communication with an information processing terminal that includes an internal memory within an IC chip that is capable of non-contact communication with a reader/writer. The internal memory includes at least one service area and an index area. The at least one service area stores a service data item that corresponds to a service that is provided through the reader/writer. The index area stores a link information item for each of the at least one service area for the purpose of accessing the service area. The information processing terminal is capable of transmitting a consistency check request to check the consistency between the index area and the at least one service area after the performing of a data transfer to the IC chip from a transfer source IC chip that is distinct from the IC chip. The program causes a computer to function as a portion that acquires the at least one link information item from the index area of the information processing terminal in response to the consistency check request from the information processing terminal. The program also causes the computer to function as a portion that determines, based on the acquired link information item, whether or not the link information item indicates an accessible service area. The program also causes the computer to function as a portion that reads, in a case where it has been determined that the link information item does indicate an accessible service area, the service area that is indicated by the link information item. The program also causes the computer to function as a portion that updates the link information item, in a case where the service area that is indicated by the link information item could not be read, with information item that does not indicate any access destination.

This program makes it possible to restore the consistency between two memory areas that are linked to one another in the transfer destination IC chip that has the memory areas and that is capable of non-contact communication with the reader/writer, in a case where the data transfer has been made from the transfer source IC chip to the transfer destination IC chip.

According to the embodiments of the present invention described above, it is possible to restore the consistency between two memory areas that are linked to one another in the transfer destination IC chip that has the memory areas and that is capable of non-contact communication with the reader/writer, in a case where the data transfer has been made from the transfer source IC chip to the transfer destination IC chip.

### BRIEF DESCRIPTION OF THE DRAWINGS

FIG. 1 is an explanatory figure that shows an example of a configuration of a memory area in a known IC chip;

FIG. 2 is an explanatory figure that shows an example of a configuration of memory areas in an IC chip according to embodiments of the present invention;

FIG. 3 is an explanatory figure that shows an overview of a data transfer according to the embodiments of the present invention;

FIG. 4 is an explanatory figure that shows an example of states of the IC chip before and after the data transfer according to the embodiments of the present invention;

FIG. 5 is a block diagram that shows a data control system according to a first embodiment of the present invention;

FIG. 6 is an explanatory figure that shows an example of consistency restoration processing according to the embodiments of the present invention; and

FIG. 7 is an explanatory figure that shows an overview of processing in the consistency restoration processing according to the embodiments of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Example of a configuration of memory areas according to the embodiments of the present invention

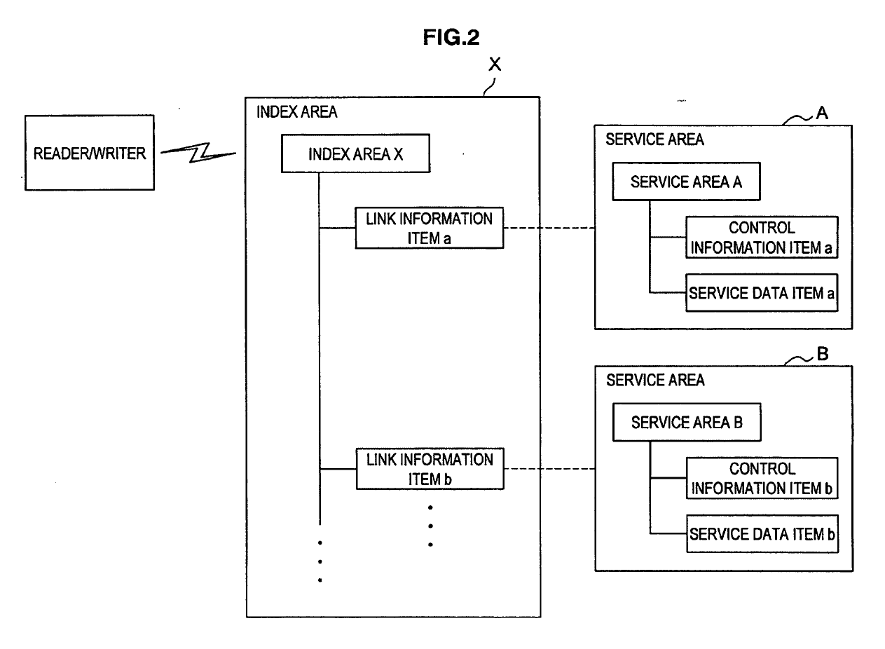

First, a configuration of memory areas in an IC chip according to the embodiments of the present invention will be explained. FIG. 2 is an explanatory figure that shows an example of the configuration of the memory areas in the IC chip according to embodiments of the present invention.

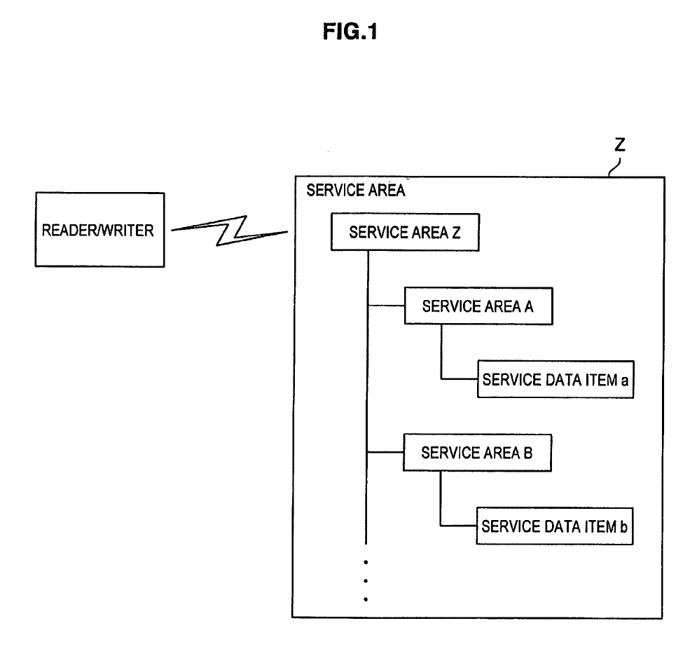

Referring to FIG. 2, the memory areas in the IC chip according to embodiments of the present invention include service areas A, B and an index area X to which the service areas A, B are individually linked. The service areas A, B can have hierarchical structures, in the same manner as a configuration of a known memory area shown in FIG. 1. In this case, an area is equivalent to a folder in the hierarchical structure. The service area A will be explained below as the service area, but the service area B is the same.

The service area A is an area in which is stored at least one of a data item for enabling a function of an information processing terminal and a data item (hereinafter called the “service data item”) for receiving a service using the IC chip, which is provided in the information processing terminal. The service area A is compatible with a variety of services. The service data item may be, for example, an electronic money value data item, a data item for personal authentication, a ticket data item, a data item that corresponds to a discount coupon, and the like, but the service data item is not limited to these examples.

The service area A can also store a control information item that indicates whether processing of the service data item that is stored in the service area A is in progress (that is, whether a transaction is in an uncompleted state) and whether the processing of the service data item is complete (that is, whether the transaction is in a completed state). The processing of the service data item may be processing that writes the service data item, for example, but it is not limited to this example. Note that in FIG. 2, control information item a is stored in the service area A, but the control information item may also be stored in the service area according to the embodiments of the present invention.

The index area X is an area that a reader/writer references in order to access each of the service areas. An information item (hereinafter called the “link information item”) that indicates a location of a service area for the purpose of accessing the service area is stored in the index area X for each of the service areas. The link information item may be an address or code that specifies the service area, an encryption key for accessing the service area, and the like, but the link information item is not limited to these examples. In FIG. 2, link information item a for accessing the service area A and link information item b for accessing the service area B are stored in the index area X.

The link information item can, for example, indicate the two states (1) and (2) shown below.

(1) Case in which the link information item indicates the address of the service area

(2) Case in which the link information item is a null value: State in which no service area is indicated (hereinafter called the “initialized state”)

Note that in (2) above, an example is given in which the link information item is the null value, but the value of the link information item that is set in the initialized state according to the embodiments of the present invention is obviously not limited to the null value.

Overview of Data Transfer

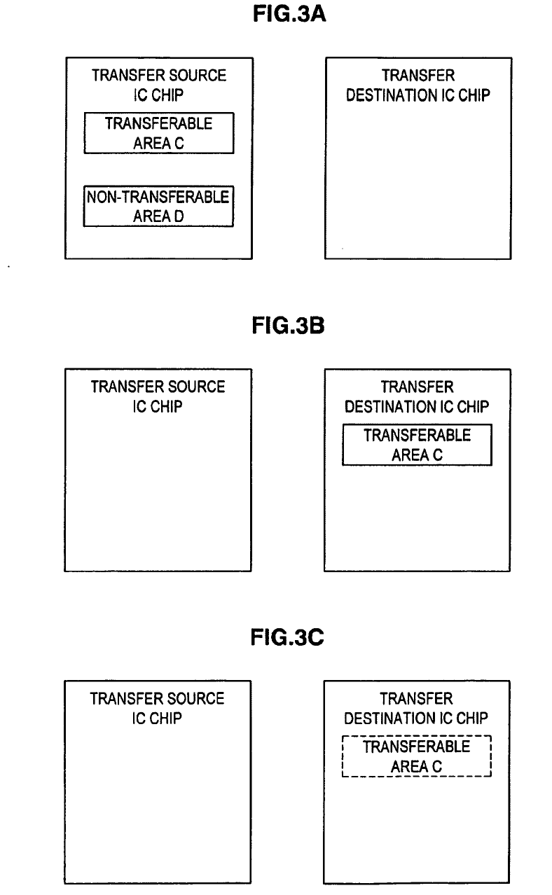

Next, an overview of a data transfer according to the embodiments of the present invention will be explained. FIG. 3 is an explanatory figure that shows an overview of the data transfer according to the embodiments of the present invention. FIG. 3A is a figure that shows a state before the data transfer from a transfer source IC chip to a transfer destination IC chip is performed. FIG. 3B is a figure that shows a state after the data transfer from the transfer source IC chip to the transfer destination IC chip is performed. FIG. 3C is a figure that shows another state after the data transfer from the transfer source IC chip to the transfer destination IC chip is performed. Note that in FIG. 3, in order to explain the overview of the data transfer, the configurations of the memory areas according to the embodiments of the present invention shown in FIG. 2 are omitted, and only the service areas are shown.

The State Before the Data Transfer: FIG. 3A

The transfer source IC chip before the data transfer includes a transferable area (service area) C from which the data can be transferred and a non-transferable area (service area) D from which the data cannot be transferred. No service area of any kind is established in the transfer destination IC chip.

A First State After the Data Transfer: FIG. 3B

When the data transfer from the transfer source IC chip to the transfer destination IC chip is performed, only the transferable area (service area) C, which is transferable, is transferred from the transfer source IC chip to the transfer destination IC chip. The non-transferable area (service area) D, the transfer of which is not permitted, is deleted from the transfer source IC chip. Therefore, the transfer destination IC chip after the data transfer includes the transferable area (service area) C, and nothing remains in the transfer source IC chip.

A Second State After the Data Transfer: FIG. 3C

When the data transfer from the transfer source IC chip to the transfer destination IC chip is performed, only the transferable area (service area) C, which is transferable, is transferred from the transfer source IC chip to the transfer destination IC chip. The non-transferable area (service area) D, the transfer of which is not permitted, is deleted from the transfer source IC chip.

At this time, attribute information to the effect that it is not possible to read the transferable area (service area) C that was transferred from the transfer source IC chip to the transfer destination IC chip may be added to the transferable area (service area) C as attribute information that indicates an attribute of the transferable area (service area) C. In this case, “not possible to read the transferable area (service area) C” does not mean that reading of the transferable area (service area) C is impossible, but rather that the transferable area (service area) C is read by a special reading procedure (for example, the transferable area (service area) C can be read only in a case where a special read command has been issued). Therefore, the second state after the data transfer, shown in FIG. 3C, indicates a state in which the transferable area (service area) C cannot be read by an ordinary procedure, even though the transferable area (service area) C resides within the transfer destination IC chip.

Hereinafter, the state in which attribute information is added to an area to the effect that it is not possible to read the area, as shown in FIG. 3C, is called the “privacy state”.

Example of a Problem Pertaining to Consistency that the Embodiments of the Present Invention Address

In the embodiments of the present invention, the data transfer is performed as shown in FIG. 3. Next, an example of a problem pertaining to consistency that the embodiments of the present invention address will be explained.

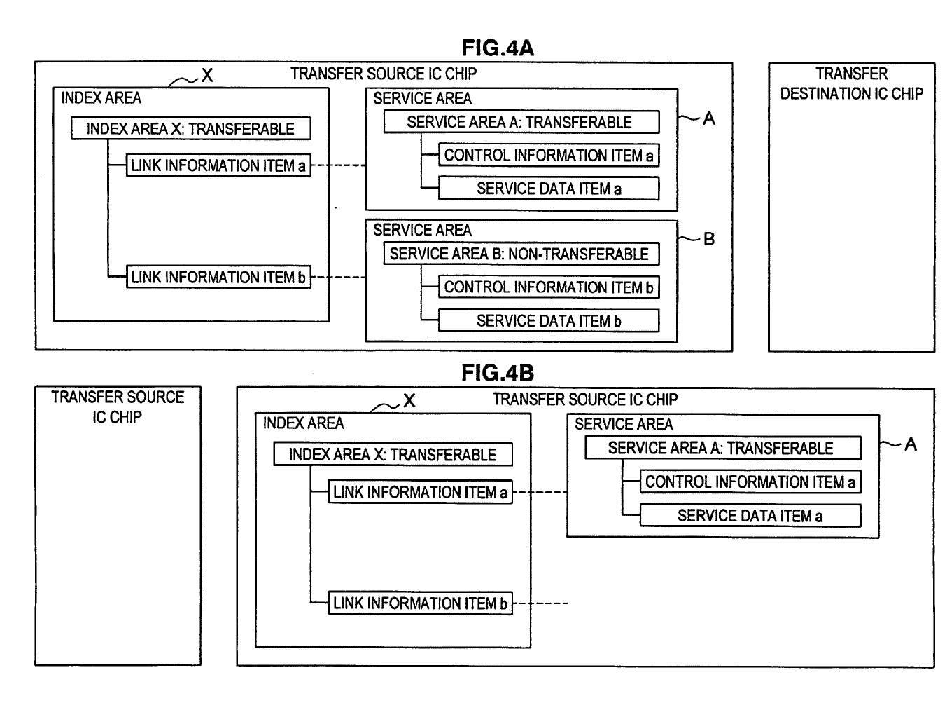

FIG. 4 is an explanatory figure that shows an example of states of the IC chip before and after the data transfer according to the embodiments of the present invention. FIG. 4A is a figure that shows the state before the data transfer from the transfer source IC chip to the transfer destination IC chip is performed. FIG. 4B is a figure that shows the state after the data transfer from the transfer source IC chip to the transfer destination IC chip is performed.

The State Before the Data Transfer: FIG. 4A

The transfer source IC chip before the data transfer includes the service areas A, B and the index area X to which the service areas A, B are individually linked. The index area X is set as a transferable area from which the data can be transferred. The link information item a that indicates the service area A and the link information item b that indicates the service area B are stored in the index area X.

The service area A is set as a transferable area from which the data can be transferred, and control information item a and service data item a are stored in the service area A. The service area B is set as a non-transferable area from which the data cannot be transferred, and control information item b and service data item b are stored in the service area B.

Further, before the data transfer, no area of any kind is established in the transfer destination IC chip.

The State After the Data Transfer: FIG. 4B

When the data transfer from the transfer source IC chip to the transfer destination IC chip is performed, the index area X and the service area A, which are the transferable areas, are transferred, and the non-transferable service area B, the transfer of which is not permitted, is deleted from the transfer source IC chip without being transferred.

However, as shown in FIG. 4B, even though the link information item b that indicates the service area B is transferred, the service area B itself is not transferred. Therefore, FIG. 4B shows a state in which the link information item b indicates a service area that does not exist, that is, a state in which an inconsistency exists between the index area and the service areas. In this case, if the reader/writer reads the link information item b, for example, an undesirable operation will occur, such as an attempt to access the non-existent service area B or the like.

### First Embodiment

Accordingly, a data control system according to a first embodiment of the present invention will be explained next that is capable of restoring a state of consistency when a state of inconsistency exists between the index area and the service area, as shown in FIG. 4B.

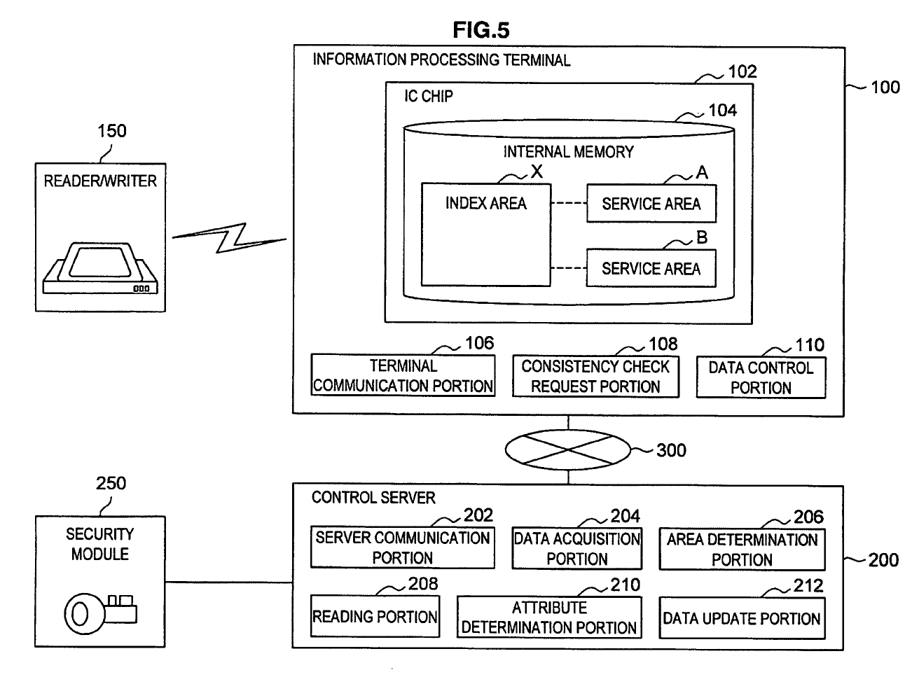

FIG. 5 is a block diagram that shows the data control system according to the first embodiment of the present invention.

Referring to FIG. 5, the data control system according to the first embodiment includes an information processing terminal 100, a reader/writer 150, a control server 200, and a security module 250. Note that in FIG. 5, the only information processing terminal shown is the information processing terminal 100, but the data control system according to the first embodiment may include a plurality of information processing terminals.

The information processing terminal 100 and the reader/writer 150 can perform non-contact communication by using a magnetic field (a carrier wave) of a specific frequency, such as 13.56 MHz or the like, for example. By using the carrier wave, the reader/writer 150 can perform non-contact reading and writing of data in an IC chip 102 (described later) that is provided in the information processing terminal 100.

The information processing terminal 100 and the control server 200 are connected by a network circuit 300. The network circuit 300 may be, for example, a wired network such as a local area network (LAN), a wide area network (WAN), or the like, or a wireless network such as a wireless local area network (WLAN) or the like that uses multiple-input and multiple-output (MIMO). The network circuit 300 may also be the Internet and utilize a communications protocol such as the Transmission Control Protocol/Internet Protocol (TCP/IP). The network circuit 300 may also be a network that is connected via a base station or the like (not shown in the drawings) that fulfills the role of a wireless LAN access point, or a network that uses short range wireless communication that utilizes infrared light, IEEE 802.11 (called “Wi-Fi”), IEEE 802.15.1, or the like, for example. However, the network circuit 300 is not limited to these examples.

The Information Processing Terminal 100

The information processing terminal 100 can include the IC chip 102, a terminal communication portion 106, a consistency check request portion 108, and a data control portion 110. The information processing terminal 100 may also include a terminal control portion (not shown in the drawings) that is configured from a micro processing unit (MPU) or the like and that controls the entire information processing terminal 100. The information processing terminal 100 may also include a terminal storage portion (not shown in the drawings) that stores data and an application that the information processing terminal 100 can execute, an operation portion (not shown in the drawings) that a user can operate, and the like. The terminal storage portion (not shown in the drawings) may be, for example, a memory such as a random access memory (RAM), a read only memory (ROM), or the like, or a magnetic storage medium such as a hard disk or the like, but it is not limited to these examples. The operation portion (not shown in the drawings) may be a button, a direction key, a rotary type selector such as a jog dial or the like, a combination of these, or the like, for example. The terminal control portion (not shown in the drawings) can also function as the consistency check request portion 108 and the data control portion 110.

The IC chip 102 embodies in an integrated circuit various portions that are involved in communication with the reader/writer 150, and it can be tamper-proof. The IC chip 102 can include, for example, an internal memory 104 and an internal communication portion (not shown in the drawings).

The internal memory 104 is a storage portion that is provided within the IC chip 102, and it can be tamper-proof. The internal memory 104, includes two areas that are linked to one another, the two areas being an index area and an at least one service area that corresponds to the index area. FIG. 5 shows the index area X and the service areas A, B as an example of the configuration of the internal memory 104.

The internal communication portion (not shown in the drawings) includes, for example, a coil that has a specified inductance and serves as a transmitting and receiving antenna and a resonance circuit that includes a capacitor that has a specified capacitance. The internal communication portion (not shown in the drawings) can receive the carrier wave that is transmitted from the reader/writer 150. By performing load modulation that varies the inductance of the information processing terminal 100 as seen from the reader/writer 150, the internal communication portion (not shown in the drawings) can perform communication with the reader/writer 150 through the carrier wave.

The terminal communication portion 106 is a portion for performing communication with an external device such as the control server 200 or the like through the network circuit 300. The terminal communication portion 106 can have a form and a function that match the type of the network circuit 300 (that is, the mode of the communication with the external device).

The consistency check request portion 108 can generate a consistency check request to check the consistency between the index area X and the service areas A, B in the internal memory 104 that is included in the IC chip 102 (the transfer destination IC chip) after data are transferred to the IC chip 102 from a transfer source IC chip that is of a different type from the IC chip 102. The consistency check request portion 108 then transmits the consistency check request to the control server 200.

The consistency check request that is generated by the consistency check request portion 108 is information that acts as a trigger for the control server 200 to start processing to check the consistency between the index area X and the service areas A, B in the internal memory 104 that is included in the IC chip 102 of the information processing terminal 100. The consistency check request may be a predetermined processing number, for example, but it is not limited to this example.

The consistency check request portion 108 can generate the consistency check request based on a user input, for example. The user input may be, for example, a specified operation in which the user who uses the information processing terminal 100 uses the operation portion (not shown in the drawings). The user input may also be a generation command that is issued by an executable application in the information processing terminal 100. The consistency check request portion 108 can also generate the consistency check request in response to a generation command that is acquired from an external device outside the information processing terminal 100, for example.

The data control portion 110 is a portion that is capable of registering and deleting an area within the internal memory 104, as well as performing reading and writing of data. The data control portion 110 can also perform processing with respect to the internal memory 104 based on various commands from the control server 200 (described later).

The Control Server 200

The control server 200 can include a server communication portion 202, a data acquisition portion 204, an area determination portion 206, a reading portion 208, an attribute determination portion 210, and a data update portion 212. The control server 200 may also include a control control portion (not shown in the drawings) that is configured from an MPU or the like and that controls the entire control server 200. The control server 200 may also include a control storage portion (not shown in the drawings) that stores data and an application that the control server 200 can execute. The control storage portion (not shown in the drawings) may be, for example, a memory such as a RAM, a ROM, or the like, or a magnetic storage medium such as a hard disk or the like, but it is not limited to these examples. The control control portion (not shown in the drawings) can also function as the data acquisition portion 204, the area determination portion 206, the reading portion 208, the attribute determination portion 210, and the data update portion 212.

The control server 200 can also include the security module 250, which stores an encryption key for accessing the internal memory 104 of the information processing terminal 100. In FIG. 5, the security module 250 is shown as a separate element from the control server 200, but it can also be provided within the control server 200. By using the encryption key that is stored in the security module 250 to access the internal memory 104 of the information processing terminal 100, the control server 200 can (directly and indirectly) access the internal memory 104 of the information processing terminal 100.

The server communication portion 202 is a portion for performing communication with an external device such as the information processing terminal 100 or the like through that network circuit 300. The server communication portion 202 has a form and a function that match the type of the network circuit 300 (that is, the mode of the communication with the external device).

The data acquisition portion 204 acquires the consistency check request from the information processing terminal 100 and, in response to the consistency check request, acquires at least one link information item that is stored in the index area X of the internal memory 104 in the IC chip 102 in the information processing terminal 100. The procedure by which the data acquisition portion 204 acquires the link information item may be, for example, that the data acquisition portion 204 transmits a link information acquisition command to the information processing terminal 100. Based on the link information acquisition command, the data control portion 110 of the information processing terminal 100 reads the link information item and sends it back to the control server 200. However, the procedure by which the data acquisition portion 204 acquires the link information item is not limited to this example.

The data acquisition portion 204 can also send the link information acquisition command to the security module 250 first, and the security module 250 can encrypt the link information acquisition command and send it to the information processing terminal 100. By using an encryption key that is shared by the IC chip 102 of the information processing terminal 100, the security module 250 can perform encrypted communication, in which the communication between the control server 200 and the information processing terminal 100 is encrypted. Note that in the explanation that follows, the communication between the control server 200 and the information processing terminal 100 can be encrypted communication, although no particular mention of encrypted communication is made.

The area determination portion 206 can use the at least one link information item that the data acquisition portion 204 acquired from the information processing terminal 100 to determine, for each link information item, whether or not the link information item indicates a location of a service area (that is, whether or not the link information item indicates an accessible service area). (This is called a first area determination.) In this case, the determination that the area determination portion 206 makes using the link information item can be, for example, a determination of whether or not the link information item is in the initialized state, but the determination is not limited to this example. In the explanation that follows, if the link information item is set to the null value, the link information item is deemed to be in the initialized state. Note that the initialization according to the embodiments of the present invention is obviously not limited to the setting of the link information item to the null value.

In a case where the area determination portion 206 determines that the link information item does indicate a location of a service area, the reading portion 208 reads the service area indicated by the link information item. The procedure by which the reading portion 208 reads the service area may be, for example, that the reading portion 208 transmits a service area read command to the information processing terminal 100. Based on the service area read command, the data control portion 110 of the information processing terminal 100 reads the service area and sends a read result back to the control server 200. Note that the read result that is read by the reading portion 208 can be, for example, a single data bit that indicates whether or not the service area could be read (for example, “0” for a failed read and “1” for a successful read), but the read result is not limited to this example and may also be the content of the service area itself.

In a case where the service area was not read by the reading portion 208, the attribute determination portion 210 determines whether or not the service area is in the privacy state. The procedure by which the attribute determination portion 210 determines whether or not the service area is in the privacy state may be, for example, that the attribute determination portion 210 transmits an attribute information check command to the information processing terminal 100 in order to check the attribute information that is set in the service area. Based on the attribute information check command, the data control portion 110 of the information processing terminal 100 checks the attribute information of the service area that could not be read by the reading portion 208 and sends it back to the control server 200. Note that a result of the check by the attribute determination portion 210 can be, for example, a single data bit that indicates whether or not the service area is in the privacy state (for example, “0” for not in the privacy state and “1” for in the privacy state), but the result is not limited to this example.

In a case where the service area that was not read by the reading portion 208 is in the privacy state, the attribute determination portion 210 determines that the service area exists, that is, that a state of consistency exists between the index area X and the service area. In a case where the service area that was not read by the reading portion 208 is not in the privacy state, the attribute determination portion 210 determines that the service area does not exist, that is, that a state of inconsistency exists between the index area X and the service area. (This is called a second area determination.)

In a case where the attribute determination portion 210 determines that a state of inconsistency exists between the index area X and the service area, the data update portion 212 performs consistency restoration processing (described later) to restore a state of consistency between the index area X and the service area, updating the link information item that is stored in the index area X of the internal memory 104 that is provided in the IC chip 102 of the information processing terminal 100. In a case where the attribute determination portion 210 determines that a state of consistency exists between the index area X and the service area, the data update portion 212 does not perform the consistency restoration processing.

Further, when the data update portion 212 completes the updating of all of the link information items that are determined to be inconsistent among the at least one link information item that is acquired by the data acquisition portion 204, the data update portion 212 can transmit to the information processing terminal 100 results information to the effect that the updating has been completed and the state of consistency has been restored, thus finishing the processing that is based on the consistency check request.

Data Control Method

Next, the manner in which the consistency restoration processing involved in the data control method according to the embodiments of the present invention restores the state of consistency between the index area X and the service area will be explained.

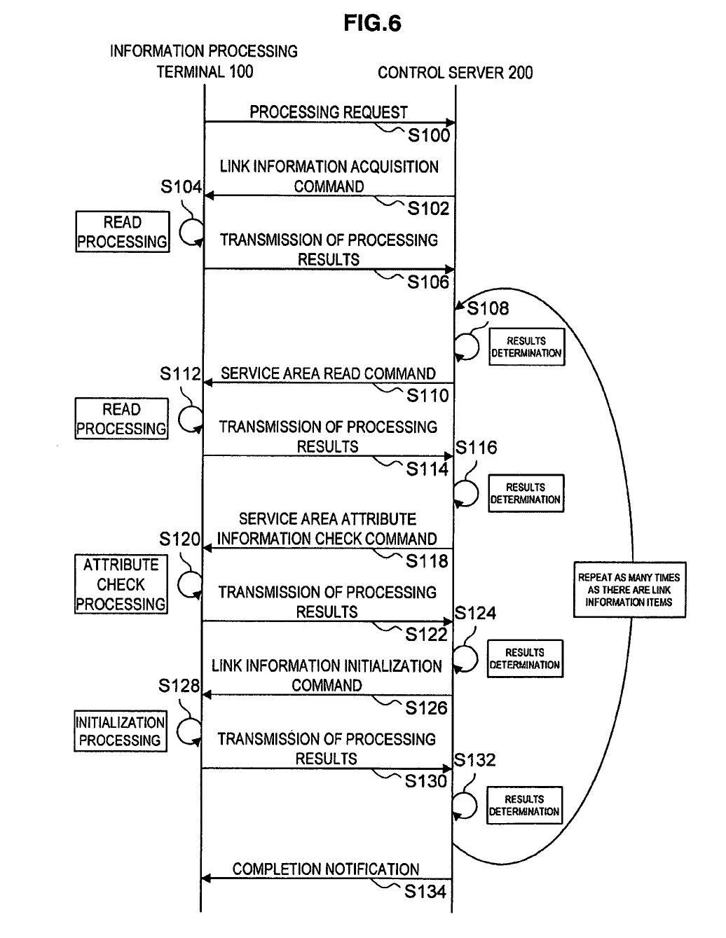

FIG. 6 is an explanatory figure that shows an example of the consistency restoration processing according to the embodiments of the present invention. Note that the consistency restoration processing according to the embodiments of the present invention is obviously not limited by FIG. 6. Note also that the communication between the control server 200 and the information processing terminal can be communication that is encrypted by the security module 250, although this is not explicitly shown in FIG. 6.

First, a processing request is transmitted from the information processing terminal 100 to the control server 200 (step S100). The processing request at step S100 indicates the consistency check request that checks the consistency between the index area X and the service areas. The transmission of the consistency check request may be performed by an operation of the user who uses the information processing terminal 100, for example. It can also be performed in response to a generation command that the information processing terminal 100 acquires from an external device after a data transfer is made from the transfer source IC chip to the IC chip 102 (the transfer destination IC chip) of the information processing terminal 100.

The control server 200, having received the consistency check request that was transmitted from the information processing terminal 100 at step S100, transmits to the information processing terminal 100 a link information acquisition command based on the consistency check request, in order to acquire the at least one link information item that is stored in the index area X of the internal memory 104 that is provided in the IC chip 102 of the information processing terminal 100 (step S102). The transmission of the link information acquisition command at step S102 can be performed by the data acquisition portion 204.

The information processing terminal 100, having received the link information acquisition command that was transmitted from the control server 200 at step S102, reads the link information item that is stored in the index area X, based on the link information acquisition command (step 104). The information processing terminal 100 then transmits to the control server 200 the at least one link information item that was read at step S104 (step S106). The read processing at step S104 can be performed by the data control portion 110 of the information processing terminal 100, for example. In the explanation that follows, each step of the processing in the information processing terminal 100 is performed by the data control portion 110, although this is not explicitly stated. However, the configuring element that performs each step of the processing in the information processing terminal 100 is obviously not limited to the data control portion 110.

The control server 200, having received the at least one link information item that was transmitted from the information processing terminal 100 at step S106, performs the processing at steps S108 to S132 below for each link information item that was received, repeating the processing as many times as there are link information items that were received.

Overview of Processing

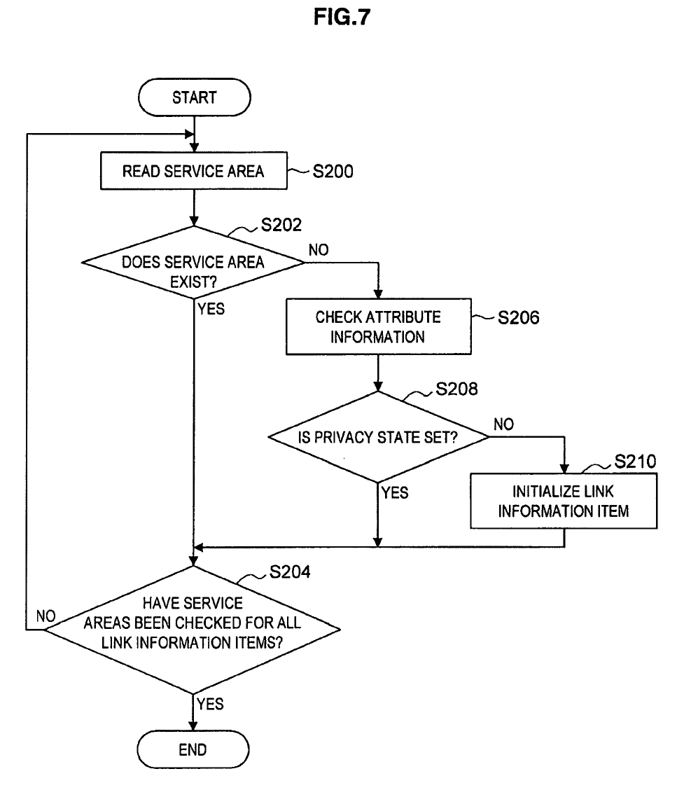

Before the processing at steps S108 to S132 is explained using FIG. 6, an overview of the processing at steps S108 to S132 will be explained with reference to FIG. 7. FIG. 7 is an explanatory figure that shows the overview of the processing in the consistency restoration processing according to the embodiments of the present invention. FIG. 7 shows the overview of the processing for one link information item.

First, the service area that is indicated by the link information item is read (step S200). Note that in the case of an initialized link information item, the processing of the link information item ends, although this is not explicitly shown in FIG. 7, and a determination is made as to whether or not all of the service areas indicated by the link information items have been checked (step S204). In a case where, at step S204, the service areas indicated by the link information items have not all been checked, the processing of the next link information item is performed starting at step S200. In a case where the service areas indicated by the link information items have all been checked, the processing ends.

A determination is made as to whether or not the service area that an attempt was made to read at step S200 exists (step S202). The determination at step S202 can be made according to whether or not the service area could be read, for example. In a case where it is determined at step S202 that the service area does exist, the link information item and the service area are consistent, so the determination is made as to whether or not the service areas indicated by the link information items have all been checked (step S204).

In a case where it is determined at step S202 that the service area does not exist, the attribute information is checked for the service area that is indicated by the link information item (step S206). Then, based on the result of the check at step S206, a determination is made as to whether or not the service area is set to the privacy state (step S208).

In a case where it is determined at step S208 that the service area is set to the privacy state, the link information item and the service area are consistent, so the determination is made as to whether or not the service areas indicated by the link information items have all been checked (step S204).

In a case where it is determined at step S208 that the service area is not set to the privacy state, the link information item and the service area are not consistent, so the link information item is initialized (step S210). The initializing of the link information item at step S210 causes the link information item not to indicate any service area at all, so the link information item and the service area can be restored to a state of consistency. Then the determination is made as to whether or not the service areas indicated by the link information items have all been checked (step S204).

As shown by the overview provided above using FIG. 7, the consistency restoration processing according to the embodiments of the present invention checks for the existence of the service area for each link information item. In a case where the service area does not exist, a state of inconsistency is deemed to exist, and a state of consistency is restored by initializing the link information item.

Next, the processing at steps S108 to S132 of the consistency restoration processing will be explained with reference once more to FIG. 6. Note that the processing at steps S108 to S132 is performed as many times as there are link information items that were transmitted from the information processing terminal 100 at step S106, and the processing at steps S108 to S132 is repeated until it is completed for all of the link information items.

For one of the at least one link information item that was transmitted from the information processing terminal 100 at step S106, the control server 200 determines whether or not the link information item indicates a service area (step S108). The determination at step S108 can be a determination of whether or not the link information item is initialized. In a case where it is determined at step S108 that the link information item does not indicate a service area, the processing at step S108 is performed for the next link information item. The determination at step S108 can be made by the area determination portion 206.

In a case where it is determined at step S108 that the link information item does indicate a service area, the control server 200 transmits to the information processing terminal 100 a read command to read the service area indicated by the link information item (step S110). The transmission of the read command at step S110 can be performed by the reading portion 208.

The information processing terminal 100, having received the read command to read the service area, reads the service area that is designated by the read command, based on the read command (step S112). The information processing terminal 100 then transmits to the control server 200 the result of the read processing at step S112 (step S114). The result of the read processing at step S112 can be, for example, a single data bit that indicates whether or not the service area could be read (for example, “0” for a failed read and “1” for a successful read), but the result is not limited to this example.

The control server 200, having received the result of the read processing that was transmitted at step S114, determines whether or not the service area could be read, based on the result of the read processing (step S116). In a case where it is determined at step S116 that the service area could be read, the processing at step S108 is performed for the next link information item. The determination at step S116 can be made by the data update portion 212, for example.

In a case where it is determined at step S116 that the service area could not be read, the attribute information check command is transmitted to the information processing terminal 100 in order to determine whether or not the service area is in the privacy state (step S118). The transmission of the attribute information check command at step S118 can be performed by the attribute determination portion 210.

The information processing terminal 100, having received the attribute information check command that was transmitted at step S118, checks whether or not the attribute information is set in the service area that is designated by the attribute information check command, based on the attribute information check command (step S120). The information processing terminal 100 then transmits the result of the attribute information check processing to the control server 200 (step S122). The result of the attribute information check processing can be, for example, a single data bit that indicates whether or not the service area is in the privacy state (for example, “0” for not in the privacy state and “1” for in the privacy state), but the result is not limited to this example.

The control server 200, having received the result of the attribute information check processing that was transmitted at step S122, determines whether or not the service area indicated by the link information item is in the privacy state (step S124). In a case where it is determined at step S124 that the service area indicated by the link information item is in the privacy state, the processing at step S108 is performed for the next link information item. The determination at step S124 can be made by the attribute determination portion 210.

In a case where it is determined at step S124 that the service area indicated by the link information item is not in the privacy state, a link information initialization command to initialize the link information item is transmitted to the information processing terminal 100 (S126). The transmission of the link information initialization command at step S126 can be performed by the data update portion 212.

The information processing terminal 100, having received the link information initialization command that was transmitted at step S126, initializes the link information item based on the link information initialization command (step S128). The information processing terminal 100 then transmits to the control server 200 the result of the initialization processing at step S128 (step S130). The result of the initialization processing can be, for example, a single data bit that indicates whether or not the initialization succeeded (for example, “0” for a failed initialization and “1” for successful initialization), but the result is not limited to this example.

The control server 200, having received the result of the initialization processing that was transmitted at step S130, determines whether or not the initialization of the link information item was performed correctly, based on the result of the initialization processing (step S132). In a case where it is determined at step S132 that the initialization of the link information item was not performed correctly, the processing at step S126 can be performed once more, or error information to the effect that the processing based on the consistency check request failed may be transmitted to the information processing terminal 100 and the processing based on the consistency check request may be terminated. The determination at step S132 can be made by the data update portion 212.

In a case where it is determined at step S132 that the initialization of the link information item was performed correctly, the processing at step S108 is performed for the next link information item.

The control server 200 repeats the processing at steps S108 to S132, described above, for each link information item. Then, when the control server 200 has performed the processing for all of the at least one link information item that was transmitted from the information processing terminal 100 at step S106, the control server 200 transmits to the information processing terminal 100 results information to the effect that the processing based on the consistency check request has been completed and the state of consistency has been restored. The control server 200 then terminates the processing based on the consistency check request (step S134). The transmission of the results information at step S134 can be performed by the data update portion 212.

For each link information item that is stored in the IC chip 102 of the information processing terminal 100, the consistency restoration processing according to the embodiments of the present invention, shown in FIG. 6 and performed mainly by the control server 200, confirms the existence of the service area indicated by the link information item. In a case where the service area indicated by the link information item does not exist, the control server 200 determines that a state of inconsistency exists and initializes the link information item. Initializing the link information item that was in a state of inconsistency causes the initialized link information item not to indicate any service area at all, so the state of inconsistency is resolved.

Accordingly, in a case where data are transferred from the transfer source IC chip to the IC chip 102 (the transfer destination IC chip) of the information processing terminal 100, even if the IC chip 102 (the transfer destination IC chip) of the information processing terminal 100 is in the state shown in FIG. 4B, the control server 200 can initialize the link information item b such that the reader/writer 150 that accesses the link information item b can be prevented from performing various types of processing, such as reading and the like, on the service area that does not exist.

As described above, in the data control system according to the first embodiment of the present invention, the information processing terminal 100 transmits the consistency check request to the control server 200. For each of the at least one link information item that is stored in the IC chip 102 of the information processing terminal 100, the control server 200, having received the consistency check request, checks the existence of the service area indicated by the link information item. In a case where the service area indicated by the link information item does not exist, the control server 200 determines that a state of inconsistency exists and initializes the link information item, thus resolving the state of inconsistency with regard to the link information item. Therefore, for each of the at least one link information item that is stored in the IC chip 102 of the information processing terminal 100, the control server 200 determines whether a state of inconsistency exists with regard to the link information item by checking the existence of the service area. By resolving the state of inconsistency, the control server 200 can restore the consistency between the service areas and the link information items that are stored in the index area X of the IC chip 102 (the transfer destination IC chip) that is provided in the information processing terminal 100 and to which the data was transferred from the transfer source IC chip.

Furthermore, the data control system according to the first embodiment of the present invention, mainly the control server 200, can control the restoration of the consistency between the service areas and the index area X of the IC chip 102. Therefore, no problems will occur as long as the information processing terminal 100 performs processing according to the commands from the control server 200, so the burden of restoring the consistency in the information processing terminal 100 is reduced.

In addition, the configuration of the memory areas within the IC chip 102 according to the first embodiment of the present invention, unlike the known configuration of the memory areas shown in FIG. 1, includes the two areas that are linked to one another, the two areas being the index area and the at least one service area that corresponds to the index area. The performing of the consistency restoration processing according to the embodiments of the present invention maintains consistency between the index area X and the service areas A, B in the IC chip 102 (the transfer destination IC chip) in the information processing terminal 100, to which the data transfer from the transfer source IC chip has been performed. By reading the link information items that are stored in the index area X, the reader/writer 150 can determine whether or not the service that correspond to the link information items have been provided to the information processing terminal 100. Therefore, in the data control system according to the first embodiment of the present invention, the reader/writer 150 can be prevented from performing various types of processing, such as the reading of the service data item and the like, with respect to a service area to which the data has not been transferred, that is, a service area that does not exist.

In the explanation above, the information processing terminal 100 was used as an example of a configuring element in the configuration of the data control system according to the first embodiment of the present invention, but the first embodiment of the present invention is not limited to this example. A mobile communication device such as a mobile telephone or the like that is equipped with an IC chip can be used, as can a computer or the like, such as an ultra mobile personal computer (UMPC) or the like that is provided with an IC chip.

Also in the explanation above, the control server 200 was used as an example of a configuring element in the configuration of the data control system according to the first embodiment of the present invention, but the first embodiment of the present invention is not limited to this example. For example, a computer or the like, such as a personal computer, a server, or the like can be used.

Program According to the First Embodiment

A program that causes a computer to function as the control server 200 according to the first embodiment can restore the consistency between the service areas A, B and the link information items that are stored in the index area X in the IC chip 102 (the transfer destination IC chip) in the information processing terminal 100, to which the data transfer from the transfer source IC chip has been performed. The program restores the consistency in response to the consistency check request that is transmitted from the information processing terminal 100 that is provided with the IC chip 102 that includes the two areas that are linked to one another, that is, the index area and the at least one service area.

### Second Embodiment

In the preceding explanation of the first embodiment, a configuration was described in which the control server 200 determines that a state of inconsistency exists by checking for the existence of the service area that corresponds to each of the at least one link information item that is stored in the IC chip 102 (the transfer destination IC chip) of the information processing terminal 100, to which the data transfer from the transfer source IC chip has been performed. The control server 200 then resolves the state of inconsistency. However, in a case where a data transfer to the IC chip 102 (the transfer destination IC chip) of the information processing terminal 100 has been performed from a transfer source IC chip in which is stored an incomplete service data item that has not been updated correctly, for example, it can happen that the service data item that is stored in the IC chip 102 (the transfer destination IC chip) of the information processing terminal 100 will be the incomplete service data item that has not been updated correctly. In this case, even if the service area that is indicated by the link information item exists, it will not be in a desirable state. (This can be said to be an example of a state of inconsistency.)

In order to resolve the undesirable state described above, a second embodiment of the present invention can determine that a state of inconsistency exists, based on whether or not the service data item that is stored in the service area was updated correctly, in addition to whether or not the service area exists.

The determination of whether or not the service data item that is stored in the service area was updated correctly can be made using the control information item, for example (refer to FIG. 2). The control information item indicates whether processing of the service data item that is stored in the service area is in progress (that is, whether a transaction is in an uncompleted state) and whether the processing of the service data item is complete (that is, whether the transaction is in a completed state).

A control server according to the second embodiment determines that a state of inconsistency exists in a case where, for example, the control information indicates that processing is in progress, even if the service area indicated by the link information item exists. The control server then resolves the state of inconsistency. At this time, the control server according to the second embodiment obviously can transmit to an information processing terminal 100 log information, for example, to the effect that the service data item that was transferred from the transfer source IC chip is incorrect.

As described above, for each of the at least one link information item that is stored in an IC chip of the information processing terminal 100, the control server according to the second embodiment can check for a state of inconsistency with regard to the link information item by checking whether or not the service area exists and whether or not the service data item is correct. In a case where the state of inconsistency is confirmed, the control server according to the second embodiment resolves the state of inconsistency. Therefore, the control server according to the second embodiment can restore the consistency between the service area and the link information item that is stored in an index area of the IC chip (the transfer destination IC chip) that is provided in the information processing terminal 100 to which a data transfer from the transfer source IC chip has been performed.

Program According to the Second Embodiment

A program that causes a computer to function as the control server according to the second embodiment can restore the consistency between the service areas and the link information items that are stored in the index area in the IC chip (the transfer destination IC chip) in the information processing terminal 100, to which the data transfer from the transfer source IC chip has been performed. The program restores the consistency in response to a consistency check request that is transmitted from the information processing terminal 100 that is provided with the IC chip that includes the two areas that are linked to one another, that is, the index area and the at least one service area.

### Third Embodiment

In the first and second embodiments described above, configurations were explained in which the control servers resolve the states of inconsistency that exist between the index area and the service areas in the IC chip (the transfer destination IC chip) in the information processing terminal 100. However, the embodiments of the present invention are not limited to configurations in which the control servers resolve the states of inconsistency that exist between the service areas and the link information items that are stored in the index area in the IC chip (the transfer destination IC chip) in the information processing terminal. For example, the information processing terminal itself can be the main element in restoring the consistency between the service areas and the link information items that are stored in the index area in the information processing terminal.

A procedure by which the information processing terminal restores the consistency between the service areas and the link information items that are stored in the index area in the IC chip (the transfer destination IC chip) that is provided in the information processing terminal, to which the data transfer from the transfer source IC chip has been performed, may be, for example, a procedure in which the information processing terminal stores and processes status information that indicates the status of processing in a consistency restoration process.

It should be understood by those skilled in the art that various modifications, combinations, sub-combinations and alterations may occur depending on design requirements and other factors insofar as they are within the scope of the appended claims or the equivalents thereof.

For example, the information processing terminal 100 that is shown in FIG. 5 is shown as having only the one IC chip 102 (the transfer destination IC chip), but the information processing terminal 100 is not limited to this example and may be provided with two or more IC chips, including the transfer source IC chip and the IC chip 102 (the transfer destination IC chip). Even in this configuration, in a case where a data transfer is performed from one IC chip (the transfer source IC chip) to another IC chip (the transfer destination IC chip), it is possible to restore consistency to the memory areas within the transfer destination IC chip.

Further, the consistency restoration processing that is shown in FIGS. 6 and 7 is shown as the data control method according to the embodiments of the present invention, but the data control method according to the embodiments of the present invention is not limited to the method that is shown in FIGS. 6 and 7. For example, the data control method according to the embodiments of the present invention can restore the consistency of the memory areas within the transfer destination IC chip by the method described in steps (a) to (d) below.

(a) Read all of the link information items (aggregate read 1).

(b) Read all of the service areas that correspond to the link information items (aggregate read 2).

(c) Perform attribute information check processing for all of service areas that could not be read (aggregate read 1, aggregate read 2).

(d) Perform updates of all of the link information items that were determined to be inconsistent based on the attribute check results.

The configurations described above are illustrative examples of the embodiments of the present invention and are naturally within the technological scope of the present invention.

What is claimed is:

1. A data control system that includes an information processing terminal and a control server, the information processing terminal being equipped with an IC chip that is capable of non-contact communication with a reader/writer and the control server being capable of communication with the information processing terminal,
wherein
the information processing terminal includes
an internal memory that is provided within the IC chip and that includes
at least one service area that stores a service data item that corresponds to a service that is provided through the reader/writer, and
an index area that stores a link information item for each of the at least one service area for the purpose of accessing the service area,
and
a consistency check request portion that transmits to the control server a consistency check request to check the consistency between the index area and the at least one service area after the performing of a data transfer to the IC chip from a transfer source IC chip that is distinct from the IC chip,
and
the control server includes
a data acquisition portion that acquires the at least one link information item from the index area of the information processing terminal in response to the consistency check request from the information processing terminal,
an area determination portion that, based on the link information item that was acquired by the data acquisition portion, determines whether the link information item indicates an accessible service area,
a reading portion that, in a case where it has been determined in the area determination portion that the link information item does indicate an accessible service area, reads the service area that is indicated by the link information item, and
a data update portion that, in a case where the service area that is indicated by the link information item could not be read by the reading portion, updates the link information item with information that does not indicate any access destination.

2. A control server that is capable of communication with an information processing terminal that includes an internal memory within an IC chip that is capable of non-contact communication with a reader/writer, the internal memory including at least one service area that stores a service data item that corresponds to a service that is provided through the reader/writer and including an index area that stores a link information item for each of the at least one service area for the purpose of accessing the service area, the information processing terminal being capable of transmitting a consistency check request to check the consistency between the index area and the at least one service area after the performing of a data transfer to the IC chip from a transfer source IC chip that is distinct from the IC chip, the control server comprising:
a data acquisition portion that acquires the at least one link information item from the index area of the information processing terminal in response to the consistency check request from the information processing terminal;
an area determination portion that, based on the link information item that was acquired by the data acquisition portion, determines whether the link information item indicates an accessible service area;
a reading portion that, in a case where it has been determined in the area determination portion that the link information item does indicate an accessible service area, reads the service area that is indicated by the link information item; and
a data update portion that, in a case where the service area that is indicated by the link information item could not be read by the reading portion, updates the link information item with information that does not indicate any access destination.

3. The control server according to claim 2, further comprising:
an attribute determination portion that, in a case where attribute information can be set for each of the at least one service area in the information processing terminal such that reading of the service area is made impossible and where the service area that is indicated by the link information item cannot be read by the reading portion, determines whether the attribute information has been set for the service area that is indicated by the link information item,
wherein the data update portion, in a case where it has been determined by the attribute determination portion that the attribute information has been set, does not update the link information item that is stored in the index area.

4. A data control method in a control server that is capable of communication with an information processing terminal that includes an internal memory within an IC chip that is capable of non-contact communication with a reader/writer, the internal memory including at least one service area that stores a service data item that corresponds to a service that is provided through the reader/writer and including an index area that stores a link information item for each of the at least one service area for the purpose of accessing the service area, the information processing terminal being capable of transmitting a consistency check request to check the consistency between the index area and the at least one service area after the performing of a data transfer to the IC chip from a transfer source IC chip that is distinct from the IC chip, the data control method comprising the steps of:
acquiring the at least one link information item from the index area of the information processing terminal in response to the consistency check request from the information processing terminal;
determining, based on the acquired link information item, whether the link information item indicates an accessible service area;
reading, in a case where it has been determined that the link information item does indicate an accessible service area, the service area that is indicated by the link information item; and
updating the link information item, in a case where the service area that is indicated by the link information item could not be read, such that the link information item does not indicate any access destination.

5. A program in a control server that is capable of communication with an information processing terminal that includes an internal memory within an IC chip that is capable of non-contact communication with a reader/writer, the internal memory including at least one service area that stores a service data item that corresponds to a service that is provided through the reader/writer and including an index area that stores a link information item for each of the at least one service area for the purpose of accessing the service area, the information processing terminal being capable of transmitting a consistency check request to check the consistency between the index area and the at least one service area after the performing of a data transfer to the IC chip from a transfer source IC chip that is distinct from the IC chip, the program comprising instructions that command a computer to function as
a portion that acquires the at least one link information item from the index area of the information processing terminal in response to the consistency check request from the information processing terminal,
a portion that determines, based on the acquired link information item, whether the link information item indicates an accessible service area;
a portion that reads, in a case where it has been determined that the link information item does indicate an accessible service area, the service area that is indicated by the link information item, and
a portion that updates the link information item, in a case where the service area that is indicated by the link information item could not be read, such that the link information item does not indicate any access destination.
